(19) United States
(12) Patent Application Publication
(10) Pub. No.: US 2007/0049106 A1
(43) Pub. Date: Mar. 1, 2007

(54) Mark displaying structure and electronic apparatus

(75) Inventors: Masato Nakatani, Kawaguchi-shi (JP); Yuji Nakajima, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/512,888

(22) Filed: Aug. 29, 2006

(30) Foreign Application Priority Data
Aug. 30, 2005 (JP) P2005-249519

(51) Int. Cl. H01R 13/58

(52) U.S. Cl. 439/466

(57) ABSTRACT

In general, according to one embodiment of the invention, a mark displaying structure on a surface of a casing comprises: a mark comprising an annularly closed outline; a wall part at least partly configuring the casing; and a mark displaying member comprising; a displaying part received in the displaying hole; and an engaging part engaged with the wall part. The wall part is exposed outside the casing and is provided with a displaying hole defined by an outer circumferential edge corresponding to the annularly closed outline of the mark.

### CROSS-REFERENCE TO RELATED APPLICATION

This application is based upon and claims the benefit of priority from Japanese Patent Application No. 2005-249519, filed on Aug. 30, 2005, the entire contents of which are incorporated herein by reference.

### BACKGROUND

1. Field

One embodiment of the invention relates to a mark displaying structure for displaying, for example, characters on a surface of a casing of an electronic apparatus, and the electronic apparatus provided with the mark displaying structure.

2. Description of the Related Art

On a surface of a casing of an electronic apparatus such as a portable computer, there are displayed marks representing a name, symbol, pattern, and so on of the apparatus.

As an example of a structure for displaying a mark as described above, a dented part corresponding to an outer circumferential shape of the mark, for example, is formed on the surface of the casing, and a seal is fitted into this dented part from outside. The mark is expressed by this structure.

It is considered, in the mark displaying structure of this type, that the seal is likely to be peeled off. When the mark has been peeled off, it would lead to deterioration of an outer appearance of the apparatus.

On the other hand, in a portable minidisk recording and reproducing apparatus or the like, an operating part is provided on the surface of the casing. The operating part of this type has an operating button to be operated by a user, and an opening formed on the surface of the casing.

The operating button is exposed to an outside of the casing, passing through the opening from an inside of the casing. The operating button is provided, at its edge, with a flange which is adapted to be engaged with an edge of the opening so that the operating button may not be detached from the opening (See JP-A-2002-197849, for example).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a portable computer according to a first embodiment of the invention, in an open state.

FIG. 2 is an exemplary perspective view of the portable computer as show in FIG. 1, in a closed state.

FIG. 3 is an exemplary enlarged view of an area encircled by a line F3 in FIG. 2.

FIG. 4 is an exemplary exploded perspective view of a mark displaying structure as shown in FIG. 3.

FIG. 5 is an exemplary enlarged perspective view showing a second wall part as shown in FIG. 4.

FIG. 6 is an exemplary perspective view showing an inner face of the second wall part as shown in FIG. 5.

FIG. 7 is an exemplary plan view of marks as shown in FIG. 3.

FIG. 8 is an exemplary enlarged perspective view showing a first member as shown in FIG. 4.

FIG. 9 is an exemplary perspective view showing a back face of the first member as shown in FIG. 8.

FIG. 10 is an exemplary enlarged perspective view showing a second member as shown in FIG. 4.

FIG. 11 is an exemplary perspective view showing a back face of the second member as shown in FIG. 10.

FIG. 12 is an exemplary perspective view showing a state in which the first member as shown in FIG. 8 has been attached to the second wall part as shown in FIG. 5.

FIG. 13 is an exemplary sectional view taken along a line F13-F13 in FIG. 3.

FIG. 14 is an exemplary perspective view of the second wall part as shown in FIG. 12, as seen from an inside of a casing.

FIG. 15 is an exemplary perspective view of the second wall part as shown in FIG. 3, as seen from the inside of the casing.

FIG. 16 is an exemplary sectional view of a second wall part of a portable computer according to a second embodiment of the invention, vertically taken along a direction in which a first to fourth marks are arranged.

FIG. 17 is an exemplary sectional view of a second wall part of a portable computer according to a third embodiment of the invention, vertically taken along a direction in which a first to fourth marks are arranged.

FIG. 18 is an exemplary plan view of a first mark and a second mark of a portable computer according to a fourth embodiment of the invention, as seen from above.

FIG. 19 is an exemplary exploded perspective view of a mark displaying structure as shown in FIG. 18.

### DETAILED DESCRIPTION

Various embodiments according to the invention will be described hereinafter with reference to the accompanying drawings. In general, according to one embodiment of the invention, a mark displaying structure on a surface of a casing comprises: a mark comprising an annularly closed outline; a wall part at least partly configuring the casing; and a mark displaying member comprising; a displaying part received in the displaying hole; and an engaging part engaged with the wall part. The wall part is exposed outside the casing and is provided with a displaying hole defined by an outer circumferential edge corresponding to the annularly closed outline of the mark.

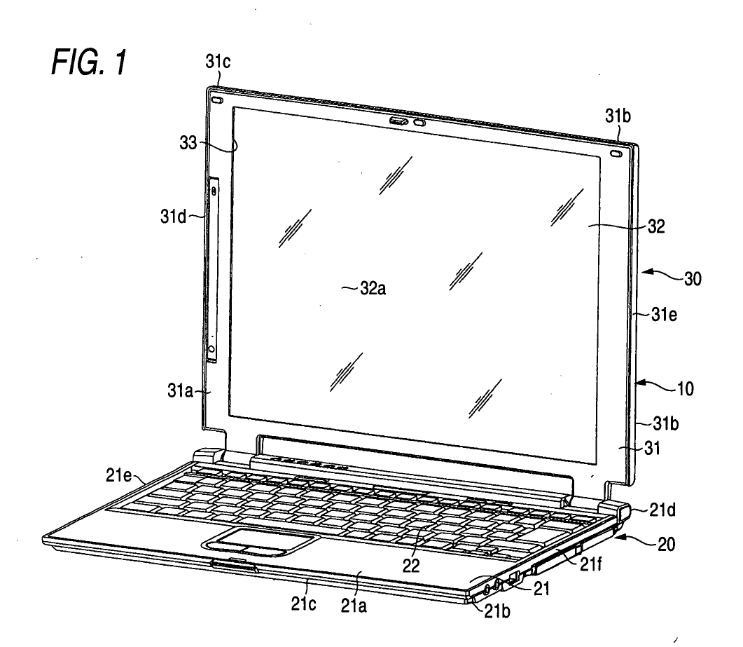

An electronic apparatus according to a first embodiment of the invention can be described, referring to FIGS. 1 to 15 in which a portable computer 10 is illustrated as an example.

FIG. 1 exemplary shows the portable computer 10. As exemplary shown in FIG. 1, the portable computer 10 includes a computer body 20 and a display unit 30.

The computer body 20 includes a computer housing 21, a keyboard 22, and so on. The computer housing 21 is in a shape of a flat box. The computer housing 21 has an upper wall part 21a, a lower wall part 21b, a front wall part 21c, a back wall part 21d, a left wall part 21e, and a right wall part 21f. The keyboard 22 is mounted on the upper wall part 21a.

The display unit 30 includes a casing 31 and a liquid crystal display panel 32.

The casing 31 is in a shape of a flat box. The casing 31 has a first wall part 31a, a second wall part 31b, a third wall part 31c, a fourth wall part 31d, and a fifth wall part 31e.

The casing 31 is coupled to the computer housing 21 by a hinge, which is not shown, so as to rotate between a closed state and an open state. The closed state is a state in which the display unit 30 is laid on the computer body 20 so as to cover the keyboard 22 from above. The open state is a state in which the display unit 30 is erected with respect to the computer body 20 so as to expose the keyboard 22 and a screen 32a, which can be described below. FIG. 1 exemplary shows the open state.

The first wall part 31a is directed forward in the open state of the display unit 30. The first wall part 31a is formed with an opening 33. An inside and an outside of the casing 31 are communicated through the opening 33.

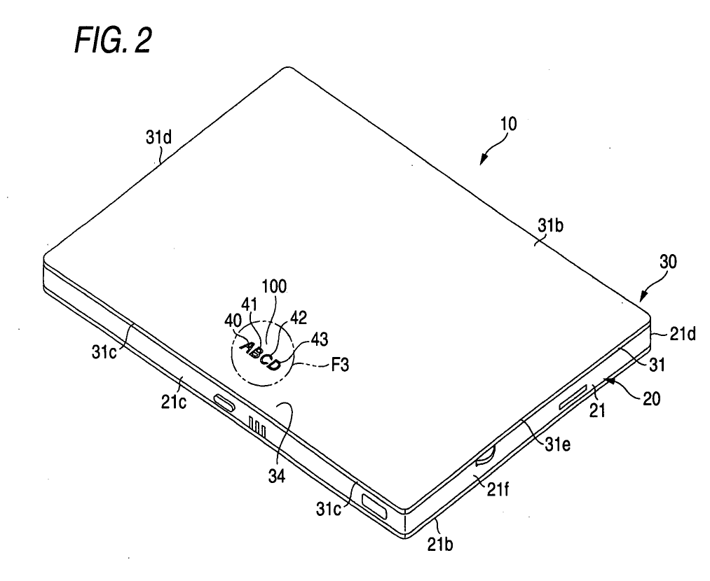

FIG. 2 exemplary shows the display unit 30 in the closed state. As exemplary shown in FIG. 2, the second wall part 31b is directed upward in the closed state of the display unit 30. As exemplary shown in FIG. 1, the third wall part 31c is coupled to an upper edge of the first wall part 31a and an upper edge of the second wall part 31b in the open state of the display unit 30.

The fourth wall part 31d is coupled to a left edge of the first wall part 31a and a left edge of the second wall part 31b. The fifth wall part 31e is coupled to a right edge of the first wall part 31a and a right edge of the second wall part 31b.

The liquid crystal display panel 32 is contained in the casing 31. The liquid crystal display panel 32 has a screen 32a for displaying an image. The screen 32a is exposed to an outside of the casing 31 through the opening 33 which is formed in the first wall part 31a of the casing 31.

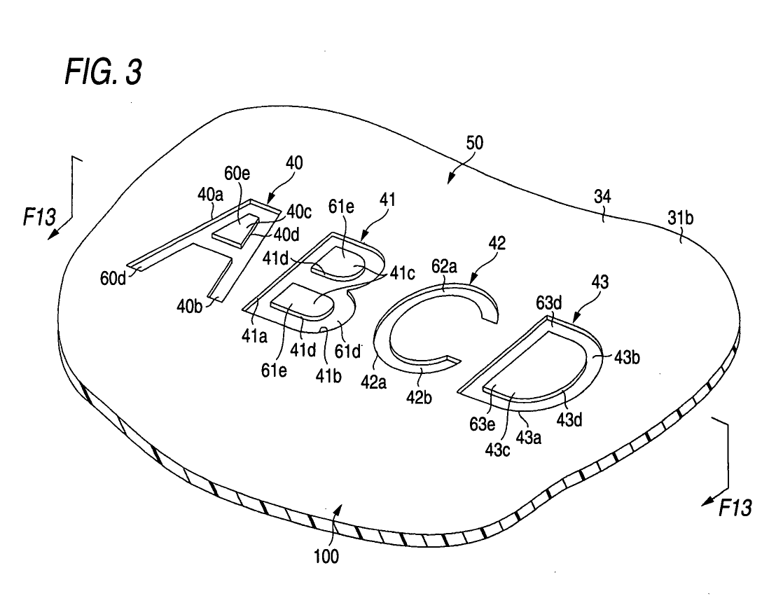

As exemplary shown in FIG. 2, a plurality of marks are displayed on a surface 34 of the second wall part 31b. FIG. 3 exemplary shows an area encircled by F3 in FIG. 2, in an enlarged manner. In this embodiment, a first mark 40, a second mark 41, a third mark 42, and a fourth mark 43 are displayed on the surface 34 of the second wall part 31b, as exemplary shown in FIGS. 2 and 3.

The first mark 40 represents a character “A”. The second mark 41 represents a character “B”. The third mark 42 represents a character “C”. The fourth mark 43 represents a character “D”.

Therefore, the portable computer 10 is provided with a mark displaying structure 50. The mark displaying structure 50 in this embodiment displays the first to fourth marks 40, 41, 42, 43.

The mark is a concept which is displayed by having an annularly closed outline. In other words, the marks “A”, “B”, “C”, and “D” are recognized as the marks, by respectively having outlines 40a, 41a, 42a and 43a.

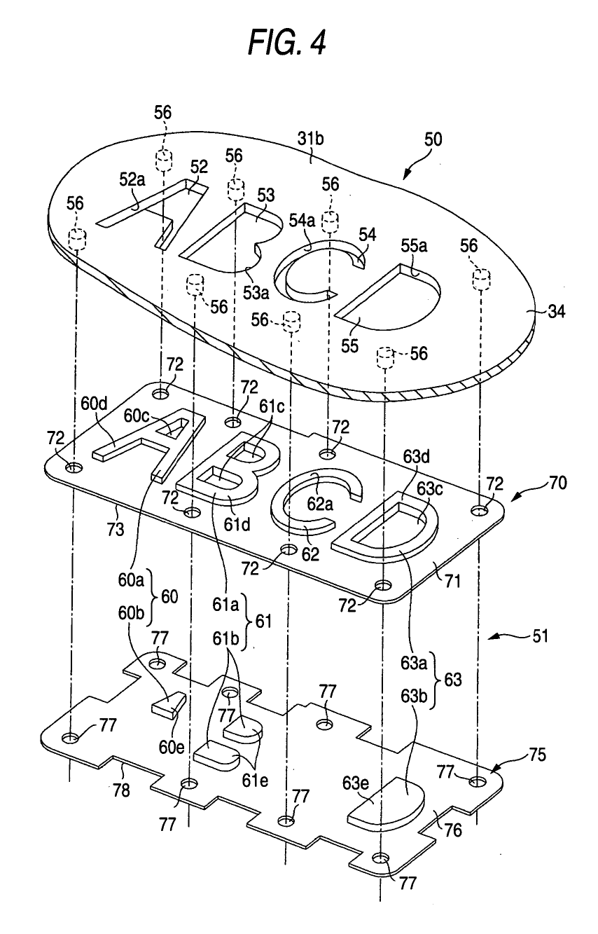

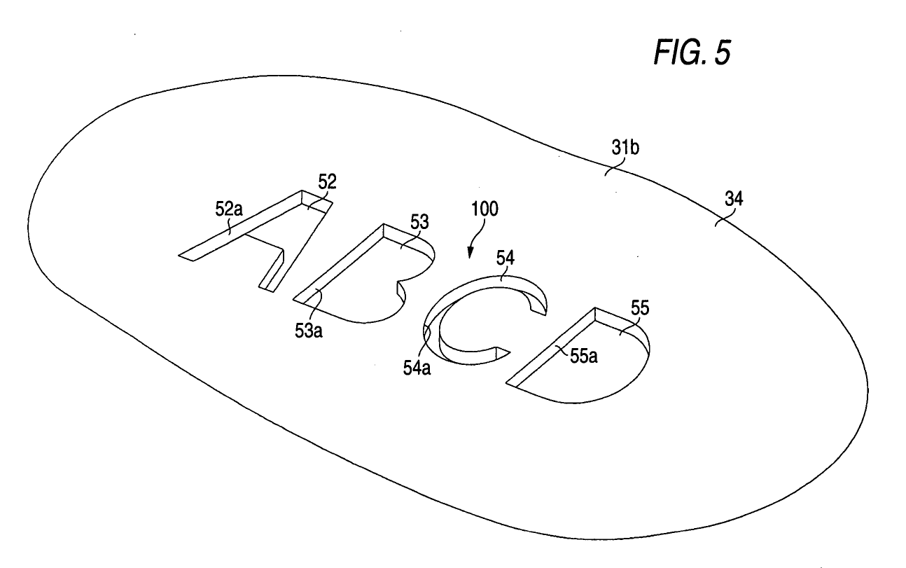

FIG. 4 exemplary shows the mark displaying structure 50 in an exploded state. As exemplary shown in FIG. 4, the mark displaying structure 50 includes the second wall part 31b and a mark displaying member 51. FIG. 5 exemplary shows the second wall part 31b in a state where a displaying part of the mark displaying member 51, which can be described below, is not contained.

As exemplary shown in FIGS. 4 and 5, first to fourth displaying holes 52, 53, 54, and 55 corresponding to the first to fourth marks 40, 41, 42, 43 are formed in the second wall part 31b.

The first displaying hole 52 passes through the second wall part 31b. An outer circumferential edge 52a of the first displaying hole 52 corresponds to the outline 40a of “A” which is represented by the first mark 40. Specifically, the outer circumferential edge 52a of the first displaying hole 52 has a substantially same shape as the outline 40a of “A”.

The second displaying hole 53 passes through the second wall part 31b. An outer circumferential edge 53a of the second displaying hole 53 corresponds to the outline 41a of “B” which is represented by the second mark 41. Specifically, the outer circumferential edge 53a of the second displaying hole 53 has a substantially same shape as the outline 41a of “B”.

The third displaying hole 54 passes through the second wall part 31b. An outer circumferential edge 54a of the third displaying hole 54 corresponds to the outline 42a of “C” which is represented by the third mark 42. Specifically, the outer circumferential edge 54a of the third displaying hole 54 has a substantially same shape as the outline 42a of “C”.

The fourth displaying hole 55 passes through the second wall part 31b. An outer circumferential edge 55a of the fourth displaying hole 55 corresponds to the outline 43a of “D” which is represented by the fourth mark 43. Specifically, the outer circumferential edge 55a of the fourth displaying hole 55 has a substantially same shape as the outline 43a of “D”.

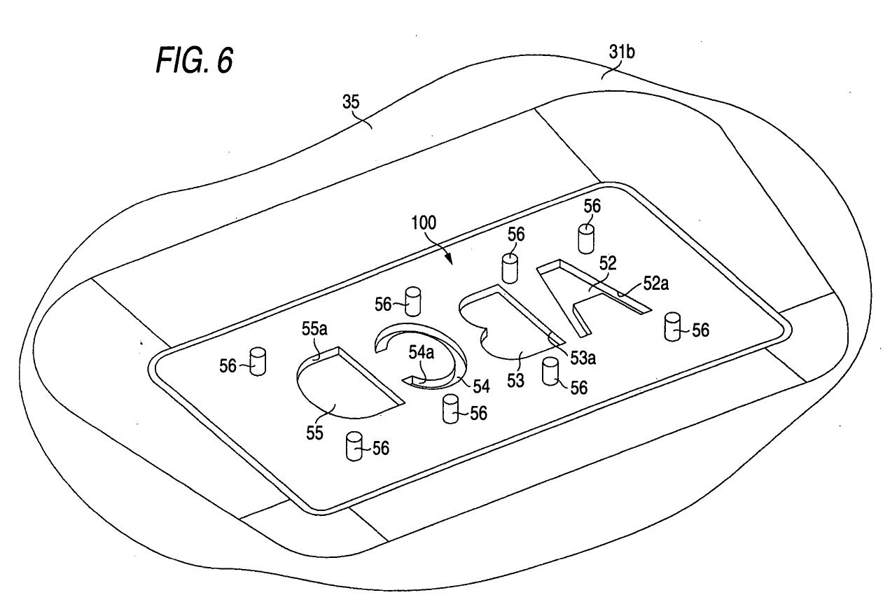

FIG. 6 exemplary shows an inner face 35 of the second wall part 31b. The inner face 35 is opposed to the inside of the casing 31. FIG. 6 exemplary shows an area 100 in which the first to fourth displaying holes 52, 53, 54, 55 are formed in the second wall part 31b, and its vicinity.

As exemplary shown in FIGS. 4 and 6, the second wall part 31b is provided with a plurality of welding pins 56. The welding pins 56 are arranged around the area 100 in which the first to fourth displaying holes 52, 53, 54, 55 are formed. The welding pins 56 respectively extend from the inner face 35 to the inside of the casing 31.

As exemplary shown in FIG. 4, the mark displaying member 51 has first to fourth displaying parts 60, 61, 62, and 63.

The first displaying part 60 can be received in the first displaying hole 52. The first displaying hole 52 can be blocked with the first displaying part 60 which has been received in the first displaying hole 52.

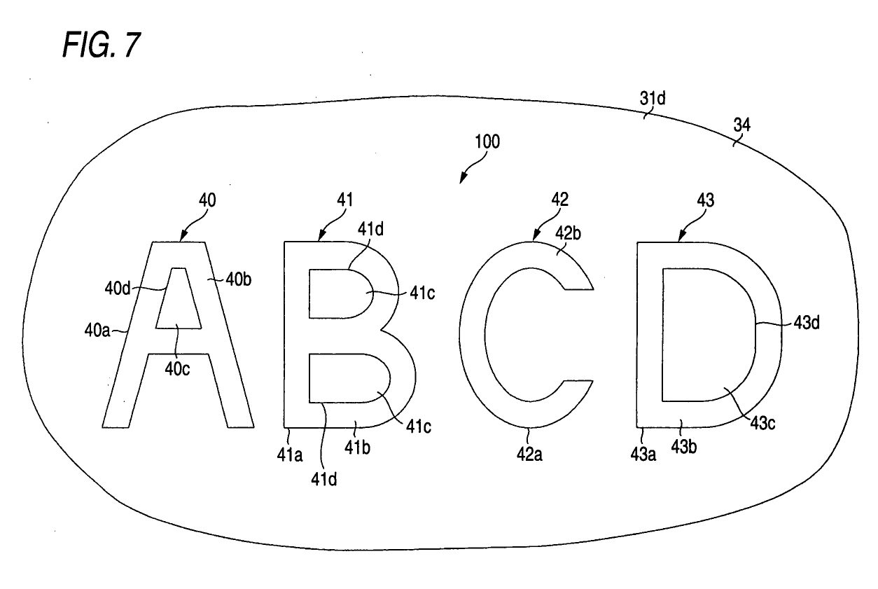

The first mark 40 can be described in detail. FIG. 7 is an exemplary plan view showing the marks 40, 41, 42, 43. As exemplary shown in FIG. 7, the first mark 40 represents “A”. A shape of the first mark 40, that is, a shape of “A” has a first closed region 40b and a second closed region 40c, and is recognized as the shape “A”, by having these first and second closed regions 40b and 40c.

Describing specifically, the first mark has a first annular line 40d in a substantially trapezoidal shape, inside the outline 40a. The first annular line 40d is closed. The first closed region 40b is a region defined between the outline 40a and the first annular line 40d. In other words, the first closed region 40b is a region located inside the outline 40a and outside the first annular line 40d. The first closed region 40b is closed.

The second closed region 40c is a region which is defined by being enclosed by the first annular line 40d. The second closed region 40c is closed.

The first annular line 40d is positioned inside the outline 40a. The outline 40a and the first annular line 40d have such positional relation that the outline 40a is positioned relatively outside, and the first annular line 40d is positioned relatively inside.

Accordingly, in the relative positional relation between the outline 40a and the first annular line 40d, the outline 40a serves as an outer annular line, and the first annular line 40d serves as an inner annular line.

As described above, the first mark 40 has a plurality of the closed regions. Therefore, the first displaying part 60 includes a first section 60a and a second section 60b, as exemplary shown in FIG. 4.

The first section 60a has a substantially same shape, in a plan view, as the first closed region 40b. The first section 60a represents the first closed region 40b, when it has been received in the first displaying hole 52.

A through hole 60c is formed in the first section 60a. The through hole 60c has a substantially same shape as the second closed region 40c. The through hole 60c passes through the first section 60a.

The second section 60b has a substantially same shape, in a plan view, as the second closed region 40c. The second section 60b represents the second closed region 40c, when it has been received in the first displaying hole 52, that is, when it has been fitted into the through hole 60c in the first section 60a.

As exemplary shown in FIG. 7, the first closed region 40b and the second closed region 40c are adjacent to each other. In other words, the first section 60a and the second section 60b become adjacent to each other, when they have been respectively received in the first displaying hole 52. As exemplary shown in FIG. 4, the first section 60a and the second section 60b are formed of separate members.

The second displaying part 61 can be received in the second displaying hole 53. The second displaying hole 53 can be blocked with the second displaying part 61 which has been received in the second displaying hole 53.

Now, the second mark 41 can be described in detail. As exemplary shown in FIG. 7, the second mark 41 represents “B”. A shape of the second mark 41, that is, a shape of “B” has a first closed region 41b and two second closed regions 41c, and is recognized as the shape “B”, by having these first and second closed regions 41b and 41c.

Describing specifically, the second mark 41 has two first annular lines 41d inside the outline 41a. The first annular lines 41d are respectively closed. The first closed region 41b is a region which is defined between the outline 41a and the respective first annular lines 41d. In other words, the first closed region 41b is the region which is located inside the outline 41a and outside the respective first annular lines 41d. The first closed region 41b is closed.

The second closed regions 41c are the regions which are respectively enclosed by the two first annular lines 41d. The second closed regions 41c are respectively closed.

The first annular lines 41d are positioned inside the outline 41a. The outline 41a and the respective first annular lines 41d have such positional relation that the outline 41a is positioned relatively outside, and the respective first annular lines 41d are positioned relatively inside.

Accordingly, in the relative positional relation between the outline 41a and the respective first annular lines 41d, the outline 41a serves as the outer annular line, and the respective first annular lines 41d serve as the inner annular lines.

Moreover, the second closed regions 41c are the closed regions which are defined by the first annular lines 41d. Therefore, in relation between the first closed region 41b and the respective second closed regions 41c, the first closed region 41b serves as a determined closed region. The respective second closed regions 41c serve as a plurality of closed regions inside the determined closed region, which are at least defined by the inner annular lines in this determined closed region.

As described above, the second mark 41 has a plurality of the closed regions. Therefore, the second displaying part 61 includes a first section 61a and two second sections 60b, as exemplary shown in FIG. 4.

The first section 61a has a substantially same shape, in a plan view, as the first closed region 41b. The first section 61a represents the first closed region 41b, when it has been received in the second displaying hole 53. The respective second sections 61b have substantially same shapes, in a plan view, as the second closed regions 41c respectively corresponding thereto.

The first section 61a is formed with a pair of through holes 61c which have substantially the same shapes, in a plan view, as the respective second sections 61b. The through holes 61c pass through the first section 61a. The second sections 61b represent the second closed regions 41c, when they have been received in the second displaying hole 53, that is, when they have been fitted into the through holes 61c in the first section 61a.

As exemplary shown in FIG. 7, the first closed region 41b and the respective second closed regions 41c are adjacent to each other. In other words, the first section 61a and the second sections 61b are adjacent to each other. As exemplary shown in FIG. 4, the first section 61a and the second sections 61b are formed of separate members.

The third displaying part 62 can be received in the third displaying hole 54. The third displaying hole 54 can be blocked with the third displaying part 62 which has been received in the third displaying hole 54.

Now, the third mark 42 can be described in detail. As exemplary shown in FIG. 7, the third mark 42 represents “C”. The third mark 42 is recognized by an outline 42a which is closed in a shape of “C”.

The third mark 42 has a first closed region 42b. The first closed region 42b is a region which is enclosed by the outline 42a. The third displaying part 62 has a substantially same shape, in a plan view, as the first closed region 42b. The third displaying hole 54 is blocked with the third displaying part 62 when it has been received in the third displaying hole 54.

The fourth displaying part 63 can be received in the fourth displaying hole 55. The fourth displaying hole 55 can be blocked with the fourth displaying part 63 which has been received in the fourth displaying hole 55.

Now, the fourth mark 43 can be described in detail. As exemplary shown in FIG. 7, the fourth mark 43 represents “D”. A shape of the fourth mark 43, that is, a shape of “D” has a first closed region 43b and a second closed region 43c, and is recognized as the shape “D”, by having these first and second closed regions 43b and 43c.

Describing specifically, the fourth mark 43 has a first annular line 43d inside an outline 43a. The first annular line 43d is closed. The first closed region 43b is a region which is defined between the outline 43a and the first annular line 43d. In other words, the first closed region 43b is the region located inside the outline 43a and outside the first annular line 43d. The first closed region 43b is closed.

The second closed region 43c is a region enclosed by the first annular line 43d. The second closed region 43c is closed.

The first annular line 43d is positioned inside the outline 43a. In other words, the outline 43a and the first annular line 43d have such positional relation that the outline 43a is positioned relatively outside, and the first annular line 43d is positioned relatively inside.

Accordingly, in the relative positional relation between the outline 43a and the first annular line 43d, the outline 43a serve as the outer annular line, and the first annular line 43d serves as the inner annular line.

As described above, the fourth mark 43 has a plurality of the closed regions. Therefore, the fourth displaying part 63 includes a first section 63a and a second section 63b, as exemplary shown in FIG. 4.

The first section 63a has a substantially same shape, in a plan view, as the first closed region 43b. The first section 63a represents the first closed region 43b, when it has been received in the fourth displaying hole 55.

The second section 63b has a substantially same shape, in a plan view, as the second closed region 43c. The first section 63a is formed with a through hole 63c which has substantially the same shape, in a plan view, as the second section 63b. The through hole 63c passes through the first section 63a.

The second section 63b represents the second closed region 43c, when it has been received in the fourth displaying hole 55, in other words, when it has been fitted into the through hole 63c in the first section 63a.

As exemplary shown in FIG. 7, the first closed region 43b and the second closed region 43c are adjacent to each other. Accordingly, the first section 63a and the second section 63b are adjacent to each other. As exemplary shown in FIG. 4, the first section 63a and the second section 63b are formed of separate members.

The first section 60a of the first displaying part 60, the first section 61a of the second displaying part 61, the third displaying part 62, and the first section 63a of the fourth displaying part 63 are integrally formed with one another, thereby to configure a part of a first member 70.

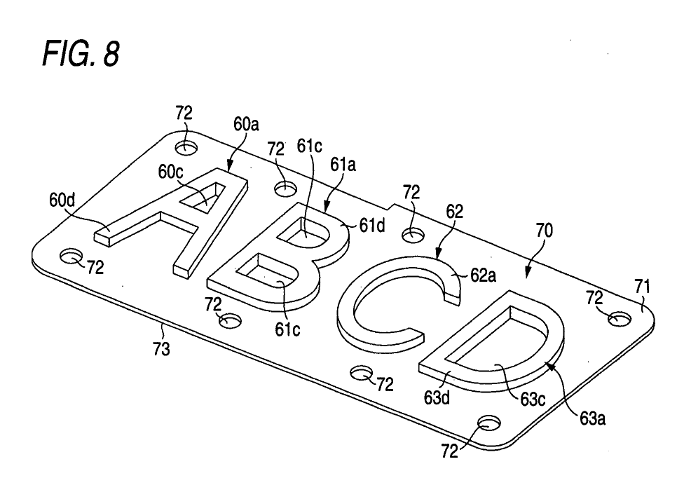

FIG. 8 exemplary shows the first member 70 in an enlarged manner. The first member 70 includes a body part 71, the first section 60a of the first displaying part 60, the first section 61a of the second displaying part 61, the third displaying part 62, and the first section 63a of the fourth displaying part 63.

The body part 71 has a plate-like shape, for example. As exemplary shown in FIG. 4, the body part 71 has such a size as covering all the first to fourth displaying holes 52, 53, 54 and 55. The body part 71 is provided with pin passing holes 72 which the welding pins 56 are adapted to pass through.

The first section 60a of the first displaying part 60, the first section 61a of the second displaying part 61, the third displaying part 62, and the first section 63a of the fourth displaying part 63 are integrally formed on the body part 71. The first section 60a of the first displaying part 60, the first section 61a of the second displaying part 61, the third displaying part 62, and the first section 63a of the fourth displaying part 63 are projected from the body part 71.

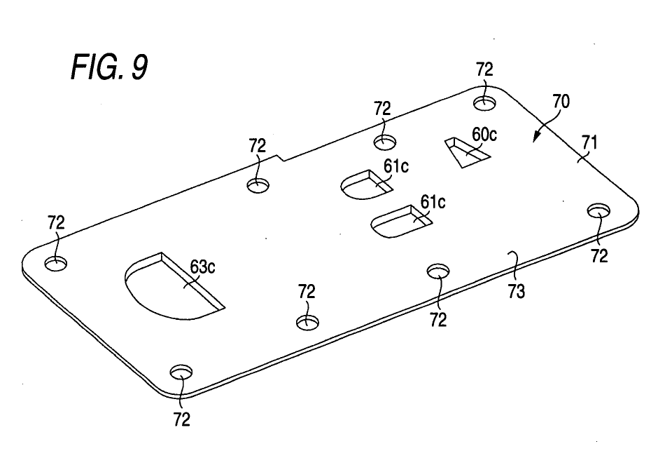

FIG. 9 exemplary shows a back face 73 of the body part 71. The back face 73 is an opposite face to a face on which the first section 60a of the first displaying part 60, the first section 61a of the second displaying part 61, the third displaying part 62, and the first section 63a of the fourth displaying part 63 are provided in the body part 71. As exemplary shown in FIG. 9, the through holes 60c, 61c, 63c pass through the body part 71.

As exemplary shown in FIG. 4, the second section 60b of the first displaying part 60, the second section 61b of the second displaying part 61, and the second section 63b of the fourth displaying part 63 described above are integrally formed on the second member 75 thereby to configure a part of the second member 75.

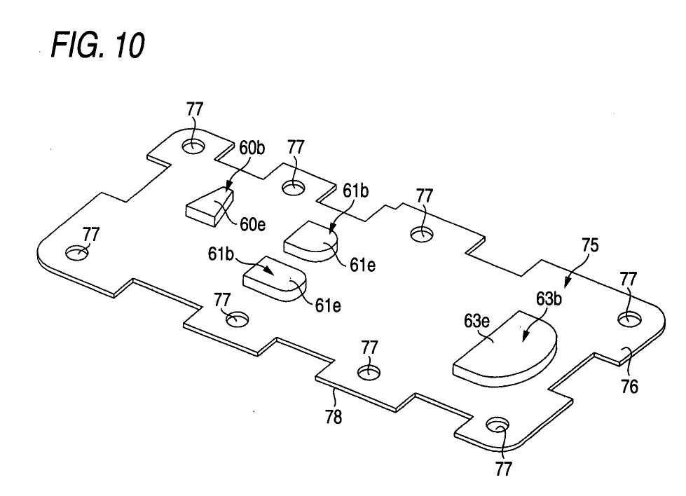

FIG. 10 exemplary shows the second member 75 in an enlarged manner. As exemplary shown in FIG. 10, the second member 75 has a body part 76, the second section 60b of the first displaying part 60, the second section 61b of the second displaying part 61, and the second section 63b of the fourth displaying part 63.

As exemplary shown in FIG. 4, the body part 76 has such a size as covering all the first to fourth displaying holes 52, 53, 54 and 55. The body part 76 is provided with pin passing holes 77 which the welding pins 56 are adapted to pass through. It would be sufficient that the body part 76 has such a size as covering only the through holes 61c, 62c, and 63c.

The second section 60b of the first displaying part 60, the second section 61b of the second displaying part 61, and the second section 63b of the fourth displaying part 63 are integrally formed on the body part 76. The second section 60b of the first displaying part 60, the second section 61b of the second displaying part 61, and the second section 63b of the fourth displaying part 63 are projected from the body part 76.

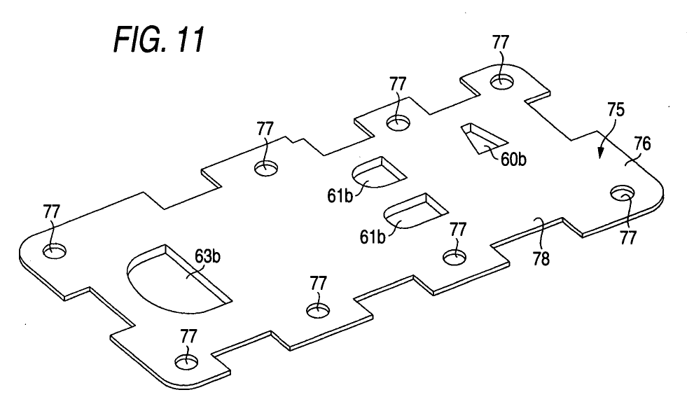

FIG. 11 exemplary shows a back face 78 of the second member 75. The back face 78 is an opposite face to a face on which the second section 60b of the first displaying part 60, the second section 61b of the second displaying part 61, and the second section 63b of the fourth displaying part 63 are provided in the body part 76.

As exemplary shown in FIG. 11, the second section 60b of the first displaying part 60, the second section 61b of the second displaying part 61, and the second section 63b of the fourth displaying part 63 are formed having hollows inside.

Then, positions of surfaces of the first to fourth displaying parts 60, 61, 62, 63 can be described.

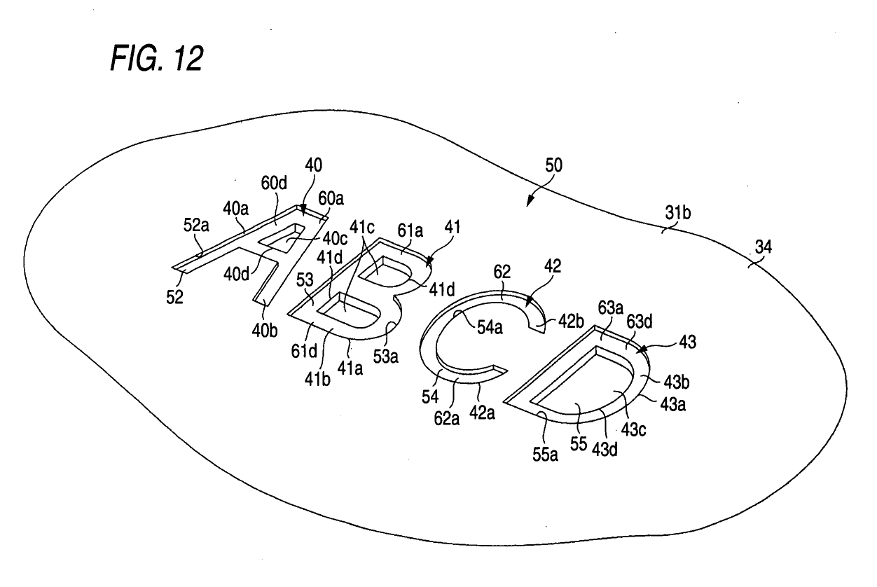

FIG. 12 exemplary shows the first member 70 in a state attached to the second wall part 31b, as seen from the surface 34 of the second wall part 31b.

Specifically, FIG. 12 exemplary shows a state where the first section 60a of the first displaying part 60 has been received in the first displaying hole 52, the first section 61a of the second displaying part 61 has been received in the second displaying hole 53, the third displaying part 62 has been received in the third displaying hole 54, and the first section 63a of the fourth displaying part 63 has been received in the fourth displaying hole 55.

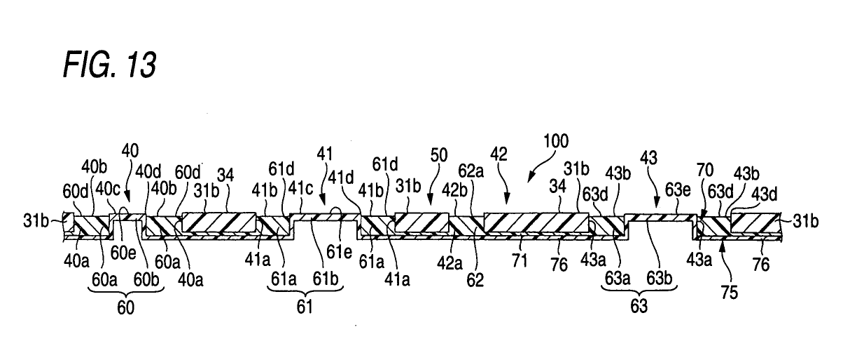

FIG. 13 is an exemplary sectional view taken along a line F13-F13 in FIG. 3. As exemplary shown in FIGS. 12 and 13, in a state where the first member 70 has been attached to the second wall part 31b, it is so set that the surface 60d of the first section 60a of the first displaying part 60 may be positioned at a lower level than an area of the surface 34 of the second wall part 31b near the outer circumferential edge 52a of the first displaying hole 52.

The surface 61d of the first section 61a of the second displaying part 61 may be positioned at a lower level than an area of the surface 34 of the second wall part 31b near the outer circumferential edge 53a of the second displaying hole 53.

The surface 62a of the third displaying part 62 is positioned at a lower level than an area of the surface 34 of the second wall part 31b near the outer circumferential edge 54a of the third displaying hole 54.

The surface 63d of the first section 63a of the fourth displaying part 63 is positioned at a lower level than an area of the surface 34 of the second wall part 31b near the outer circumferential edge 55a of the fourth displaying hole 55.

For example, the surface 60d of the first section 60a of the first displaying part 60, the surface 61d of the first section 61a of the second displaying part 61, the surface 62a of the third displaying part 62, and the surface 63d of the first section 63a of the fourth displaying part 63 may be positioned on the same level.

Moreover, in a state where the second member 75 has been attached to the second wall part 31b, as exemplary shown in FIGS. 3 and 13, the surface 60e of the second section 60b of the first displaying part 60 is positioned on a different level from the surface 60d of the first section 60a of the first displaying part 60. For example, the surface 60e of the second section 60b may be positioned on the same level as the surface 34 of the second wall part 31b.

The surface 61e of the second section 61b of the first displaying part 61 is positioned on a different level from the surface 61d of the first section 61a of the first displaying part 61. For example, the surface 61e of the second section 61b may be positioned on the same level as the surface 34 of the second wall part 31b.

The surface 63e of the second section 63b of the fourth displaying part 63 is positioned on a different level from the surface 63d of the first section 63a. For example, the surface 63e of the second section 63b may be positioned on the same level as the surface 34 of the second wall part 31b.

Now, an example of assembling steps of the mark displaying structure 50 can be described.

As a first step, the first and second members 70, 75 are positioned in such a manner that the first to fourth displaying parts 60, 61, 62, 63 may be opposed to the first to fourth displaying holes 52, 53, 54, 55, as exemplary shown in FIG. 4.

Then, the first member 70 is attached to an inner face 35 of the second wall part 31b so that the first sections 60a, 61a, 63a and the third displaying part 62 may be received in the corresponding displaying holes 52, 53, 54, 55.

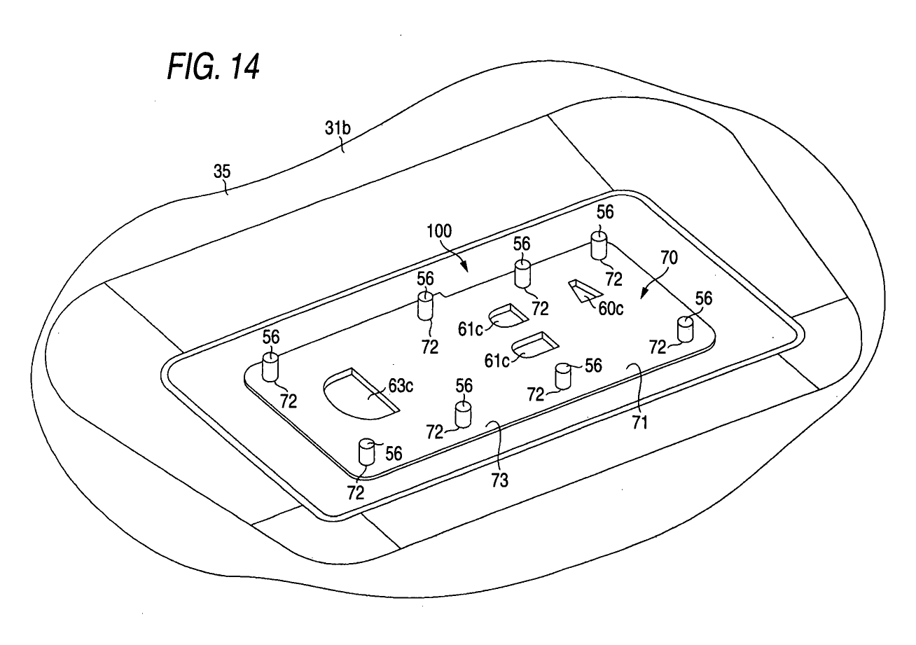

FIG. 14 exemplary shows the first member 70 in a state attached to the second wall part 31b. As exemplary shown in FIG. 14, the welding pins 56 pass through the pin passing holes 72 which are formed in the body part 71.

As exemplary shown in FIGS. 13 and 14, in the state where the first member 70 has been attached to the second wall part 31b, the body part 71 is in contact with the inner face 35 of the second wall part 31b. The body part 71 serves as an engaging part. Therefore, the first sections 60a, 61a, 63a and the third displaying part 62 are not be withdrawn to outside through the displaying holes 52, 53, 54, 55.

Then, the second member 75 is attached, as exemplary shown in FIG. 4. The second member 75 is attached in such a manner that the respective second sections 60b, 61b, 63b may pass through the corresponding holes 60c, 61c, 63c.

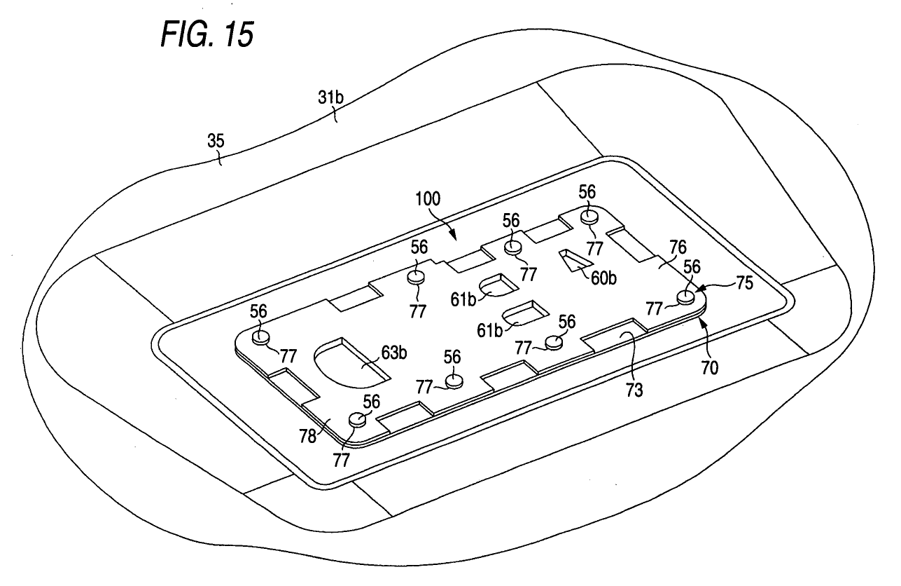

FIG. 15 exemplary shows the second member 75 in a state attached to the second wall part 31b, that is, the back face 73 of the first member 70. As exemplary shown in FIG. 15, the welding pins 56 pass through the pin passing holes 77.

As exemplary shown in FIGS. 13 and 15, in the state where the second member 75 has been attached to the back face 73 of the first member 70, the body part 76 of the second member 75 is in contact with the back face 73 of the first member 70. In short, the body part 76 serves as the engaging part. Therefore, the respective second sections 60b, 61b, 63b are not be withdrawn to the outside through the displaying holes 52, 53, 54, 55.

The welding pins 56 can be crushed, after they have passed through the pin passing holes 77. Because the welding pins 56 have been crushed, the first and second members 70, 75 can be restrained from being detached from the second wall part 31b.

The steps of attaching the first and second members 70, 75 are not limited to the above described steps. For example, it is possible to attach an integral body of these members to the second wall part 31b, after the second member 75 has been attached to the first member 70.

In the portable computer 10 provided with the mark displaying structure 50 having the above described structure, the first and second members 70, 75 can be attached to the second wall part 31b from an inside to an outside of the casing 31. Thus, the respective body parts 71, 76 can be engaged with the second wall part 31b in a direction from the inside to the outside.

The first to fourth displaying parts 60, 61, 62, 63 are not withdrawn to the outside through the first to fourth displaying holes 52, 53, 54, 55. Accordingly, because the first to fourth marks 40, 41, 42, 43 can not be detached, deterioration of the outer appearance of the mark can be restrained.

In case where the first, second and fourth marks 40, 41, 43 have the first closed regions 40b, 41b, 43b which are respectively defined between the outlines 40a, 41a, 43a and the first annular lines 40d, 41d, 43d, and the second closed regions 40c, 41c, 43c which are respectively defined by the first annular lines 40d, 41d, 43d, as in this embodiment, the first, second and fourth displaying parts 60, 61, 63 have the first sections 60a, 61a, 63a and the second sections 60b, 61b, 63b corresponding to the first and second closed regions.

In this manner, the first and second regions can be easily expressed by the first, second and fourth displaying parts 60, 61, 63, and therefore, shapes of the first, second and fourth marks 40, 41, 43 can be able to be easily expressed.

Moreover, in case where the first closed regions 40b, 41b, 43b and the second closed regions 40c, 41c, 43c are respectively adjacent to each other, as in the first, second and fourth marks 40, 41, 43, it can be possible to distinguish the first closed regions 40b, 41b, 43b from the second closed regions 40c, 41c, 43c, more distinctly, by forming the first sections 60a, 61a, 63a and the second sections 60b, 61b, 63b on the separate members, namely, on the first member 70 and the second member 75, in this embodiment.

Moreover, in case where a determined closed region has a plurality of closed regions inside, which are at least defined by the inner annular lines, the sections corresponding to these closed regions may be integrally formed with one another, whereby the number of components can be reduced.

Specifically, in case where the two second closed regions 41c defined by the first annular lines 41d are present inside the first closed region 41b, as in the second mark 41, the second sections 61b representing these second closed regions 41c may be integrally formed on the second member 75, whereby the number of the components can be reduced.

Moreover, in case where a plurality of the marks are displayed, the closed regions the respective marks having the same number in order, in an inward direction from the outlines of the marks may be integrally formed with one another, whereby the number of the components can be reduced.

This can be described more specifically. The first closed region 40b of the first mark 40 is a first closed region in order, in the inward direction from the outline 40a. The first closed region 41b of the second mark 41 is a first closed region in order, in the inward direction from the outline 41a. The first closed region 42b of the third mark 42 is a first closed region in order, in the inward direction from the outline 42a. The first closed region 43b of the fourth mark 43 is a first closed region in order, in the inward direction from the outline 43a.

Moreover, the first sections 60a, 61a, 63a and the third displaying part 62 representing the first closed regions 40b, 41b, 42b, 43b are integrally formed on the first member 70. In this manner, the closed regions adjacent to one another are formed by separate members, and the number of the components can be reduced.

The second closed region 40c of the first mark 40 is a second closed region in order, in the inward direction from the outline 40a. The second closed region 41c of the second mark 41 is a second closed region in order, in the inward direction from the outline 41a. The second closed region 43c of the fourth mark 43 is a second closed region in order, in the inward direction from the outline 43a.

The second sections 60b, 61b, 63b representing the second closed regions 40c, 41c, 43c are integrally formed on the second member 75. In this manner, the closed regions adjacent to one another are formed by separate members, and the number of the components can be reduced.

Moreover, the surfaces 60d, 61d, 63d of the first sections 60a, 61a, 63a and the surface 62 of the third displaying part 62 are positioned on a different level from the surface 34 of the second wall part 31b. Further, the surfaces 60d, 61d, 63d of the first sections 60a, 61a, 63a are positioned on a different level from the surfaces 60e, 61e, 63e of the second sections 60b, 61b, 63b.

The first to fourth marks 40, 41, 42, 43 can be expressed three-dimensionally, and the outer appearance can be improved.

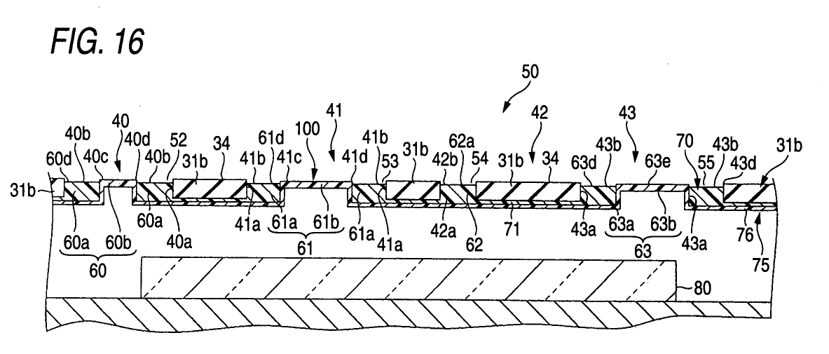

A portable computer 10 according to a second embodiment of the invention can be exemplary described referring to FIG. 16. It is to be noted that the components having the same functions as in the first embodiment can be denoted with the same reference numerals, and their description can be omitted.

The embodiment is different from the first embodiment in that the mark displaying structure 50 is additionally provided with a light source 80. Other features may be the same. This can be specifically described below.

In FIG. 16, the area 100 of the second wall part 31b in which the first to fourth marks 40, 41, 42, 43 are formed is shown in vertical section taken along a direction in which the first to fourth marks 40, 41, 42, 43 are arranged.

As exemplary shown in FIG. 16, the mark displaying structure 50 of this embodiment is additionally provided with the light source 80. As the light source 80, a light emitting element such as an LED may be employed. The light source 80 is mounted on a mounting part 81 which is provided inside the casing 31. The light source 80 is arranged at a position opposed to the first to fourth displaying holes 52, 53, 54, 55. The light source 80 may be located at such a position that it can illuminate the respective displaying parts, irrespective of whether directly or indirectly.

In the embodiment, the first member 70 is formed of a transparent body, and the second member 75 is formed of a nontransparent body. Because the first member 70 transmits the light, while the second member 75 does not transmit the light, the light irradiated from the light source 80 can be introduced to the outside of the casing 31 through the first sections 60a, 61a, 63a and the third displaying part 62.

Accordingly, in addition to an effect of the first embodiment, an effect of recognizing the first to fourth marks 40, 41, 42, 43 can be enhanced.

The second member 75 is formed of the nontransparent member in the embodiment. The second member 75 may be formed of a transparent body which transmits the light.

In this case, the first member 70 and the second member 75 may be the transparent bodies having different colors from each other. For example, the first member 70 may be the transparent body having red color, and the second member 75 may be the transparent body having blue color.

The first to fourth marks 40, 41, 41, 43 can be illuminated with the color of the first to fourth displaying parts 60, 61, 62, 63, and their shapes can be further clearly recognized. In this manner, the recognizing effect can be enhanced.

Moreover, although the one light source 80 is employed in the embodiment. Four light sources 80 may be respectively employed for the marks 40, 41, 42, 43. Alternatively, the light source 80 may be commonly employed for several marks.

Further, in the first and second members 70 and 75, only the first to fourth displaying parts 60, 61, 62, 63 may be formed of transparent bodies. The light source 80 may be flickered. By making the light source 80 flicker, the recognizing effect can be enhanced.

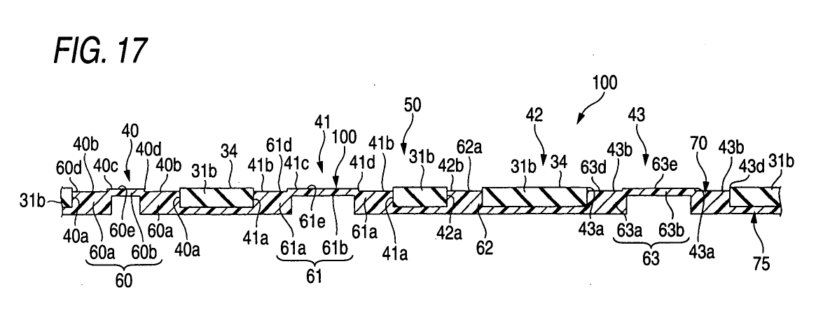

Now, a portable computer 10 according to a third embodiment of the invention can be exemplary described as an example, referring to FIG. 17. It is to be noted that the components having the same functions as in the first embodiment can be denoted with the same reference numerals, and their description can be omitted.

The embodiment is different from the first embodiment in that the first sections 60a, 61a, 63a and the second sections 60b, 61b, 63b are integrally formed. Other features may be the same. This can be specifically described below.

In FIG. 17, the area 100 of the second wall part 31b in which the first to fourth marks 40, 41, 42, 43 are formed is shown in vertical section taken along a direction in which the first to fourth marks 40, 41, 42, 43 are arranged.

As exemplary shown in FIG. 17, the second sections 60b, 61b, 63b are integrally formed on the first member 70.

The number of components is reduced in this embodiment, in addition to the effect of the first embodiment, it is possible to reduce the cost.

The structure of including the light source 80 may be employed in this embodiment too, in the same manner as in the second embodiment.

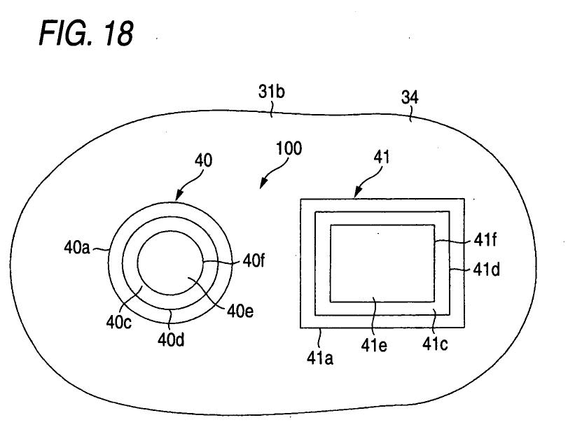

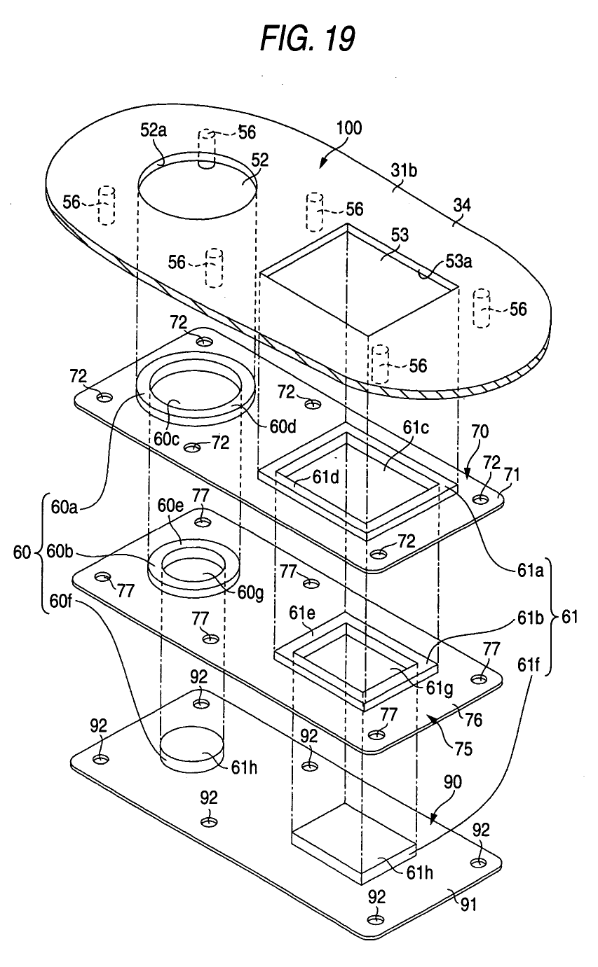

Now, a portable computer 10 according to a fourth embodiment of the invention can be exemplary described as an example, referring to FIGS. 18 and 19. It is to be noted that the components having the same functions as in the first embodiment can be denoted with the same reference numerals, and their description can be omitted.

In the embodiment, the mark displaying structure 50 displays a first mark 40 and a second mark 41. FIG. 18 is an exemplary plan view showing the first mark 40 and the second mark 41 as seen from the above.

As exemplary shown in FIG. 18, the first mark 40 additionally has a third closed region 40e in a shape of triple circles.

Describing specifically, the first mark 40 in this embodiment further has a second annular line 40f inside a first annular line 40d. The second annular line 40f is closed. An outline 40a and the first and second annular lines 40d, 40f are substantially circular, and concentrically arranged.

In the embodiment, a second closed region 40c is a region defined between the first annular line 40d and the second annular line 40f. In other words, the second closed region 40c is the region located inside the first annular line 40d and outside the second annular line 40f. The second closed region 40c is closed.

The third closed region 40e is a region which is defined by being enclosed by the second annular line 40f. The second annular line 40f is positioned inside the first annular line 40d. In positional relation between the first annular line 40d and the second annular line 40f, the first annular line 40d is positioned relatively outside, and the second annular line 40f is positioned relatively inside.

In relative positional relation between the first annular line 40d and the second annular line 40f, the first annular line 40d serves as the outer annular line, and the second annular line 40f serves as the inner annular line.

As described above, the first mark 40 has the third closed region 40e. Therefore, a first displaying part 60 additionally has a third section 60f.

FIG. 19 exemplary shows the mark displaying structure 50 in this embodiment, in an exploded manner. As exemplary shown in FIG. 19, a second section 60b is provided with a through hole 60g. The through hole 60g has a substantially same shape as the third closed region 40e. The through hole 60g passes through the second section 60b.

The third section 60f has a substantially same shape, in a plan view, as the third closed region 40e. The third section 60f represents the third closed region 40e, when it has been received in a first displaying hole 52, in other words, when it has been engaged with the through hole 60g in the second section 60b.

As exemplary shown in FIG. 18, the second closed region 40c and the third closed region 40e are adjacent to each other. In other words, the second section 60b and the third section 60f are adjacent to each other when they have been received in the first displaying hole 52. As exemplary shown in FIG. 19, the first to third sections 60a, 60b, 60c are separately formed.

As exemplary shown in FIG. 18, a second mark 41 in this embodiment additionally has a third closed region 41e which has a rectangular shape.

Describing specifically, the second mark 41 additionally has a second annular line 41f inside a first annular line 41d. The second annular line 41f is closed. The outline 41a, and the first and second annular lines 41d, 41f respectively have substantially rectangular shapes.

In this embodiment, a second closed region 41c is a region defined between the first annular line 41d and the second annular line 41f. In other words, the second closed region 41c is the region located inside the first annular line 41d and outside the second annular line 41f. The second closed region 41c is closed.

The third closed region 41e is a region which is defined by being enclosed by the second annular line 41f. The second annular line 41f is positioned inside the first annular line 41d. In positional relation between the first annular line 41d and the second annular line 41f, the first annular line 41d is positioned relatively outside, and the second annular line 41f is positioned relatively inside.

Therefore, in relative positional relation between the first annular line 41d and the second annular line 41f, the first annular line 41d serves as the outer annular line, and the second annular line 41f serves as the inner annular line.

As described above, the first mark 41 has the third closed region 41e. Therefore, a first displaying part 61 has a third section 61f.

As exemplary shown in FIG. 19, a second section 61b is provided with a through hole 61g. The through hole 61g has a substantially same shape as the third closed region 41e. The through hole 61g passes through the second section 61b.

The third section 61f has a substantially same shape, in a plan view, as the third closed region 41e. The third section 61f represents the third closed region 41e, when it has been received in a second displaying hole 53, in other words, when it has been engaged with the through hole 61g in the second section 61b.

The second closed region 41c and the third closed region 41e are adjacent to each other. In other words, the second section 61b and the third section 61f are adjacent to each other when they have been received in the second displaying hole 53. As exemplary shown in FIG. 19, the first to third sections 61a, 61b, 61c are separately formed.

The third section 60f of the first displaying part 60 and the third section 61f of the second displaying part 61 having the above described structures are integrally formed, and configures a part of a third member 90.

The third closed region 40e of the first mark 40 is a third closed region in order, in an inward direction from the outline 40a. The third closed region 41e of the second mark 41 is a third region in order, in the inward direction from the outline 41a.

The third member 90 has a body part 91, and the third sections 40e, 41e. The body part 91 has such a size as covering the first and second displaying holes 52, 53. However, the size of the body part 91 is not limited to the case. The body part 91 has such a size as covering the through holes 60g, 61g which are formed in the second member 75. The third sections 60f, 61f are integrally formed on the body part 91. The body part 91 is provided with pin passing holes 92 which the welding pins 56 are adapted to pass through.

In a state where the third member 90 has been fitted to the second wall part 31b, that is, to the second member 75, surfaces 60h, 61h of the third sections 60f, 61f are positioned on a different level from surfaces 60e, 61e of the second sections 60b, 61b. For example, the surfaces 60h, 61h of the third sections 60f, 61f may be on the same level as the surfaces 60d, 61d of the first sections 60a, 61a.

In the embodiment, substantially the same effect as in the first embodiment can be obtained. The first to third members 70, 75, 90 in the embodiment may be formed of transparent materials, as described in the second embodiment. Moreover, the first to third sections may be integrally formed with one another, as shown in the third embodiment.

In the first to third embodiments, the case where the mark has the first closed region and the second closed region has been introduced, and in the fourth embodiment, the case where the mark has the first to third closed regions has been introduced. The mark may have much more closed regions.

Moreover, in the first to third embodiments, characters are displayed as the marks, and in the fourth embodiment, simple figures are displayed as the marks. A mark of a company and a picture may be displayed. While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A mark displaying structure on a surface of a casing comprising: a mark comprising an annularly closed outline; a wall part at least partly configuring the casing, the wall part exposed outside the casing and provided with an displaying hole defined by an outer circumferential edge corresponding to the annularly closed outline of the mark; and
a mark displaying member comprising; a displaying part received in the displaying hole; and an engaging part engaged with the wall part.

2. A mark displaying structure according to claim 1, wherein, in case where the mark comprises; at least one closed region defined between an outer annular line and an inner annular line which are positioned relatively outside and inside, and annularly closed; and another closed region defined by being enclosed by the inner annular line, a portion of the displaying part is respectively corresponding to each closed region.

3. A mark displaying structure according to claim 2, wherein the portion of the displaying part corresponding to each closed region is integrally formed.

4. A mark displaying structure according to claim 2, wherein the portion of the displaying part adjacent to each other, other than the portion of the displaying part corresponding to the closed region, is independently formed.

5. A mark displaying structure according to claim 4, wherein, in case where a plurality of closed regions at least defined by the inner annular line is included in a predetermined closed region out of a plurality of closed regions, a portion defined by the plurality of closed regions is integrally formed.

6. A mark displaying structure according to claim 4, wherein, in case where a plurality of the marks are displayed, the closed region of each of the plurality of marks having the same number in order in an inward direction from the outline is integrally formed.

7. A mark displaying structure according to claim 1, wherein a light source is provided, and wherein the mark displaying part is formed of a transparent material.

8. A mark displaying structure according to claim 2, wherein portion of the displaying part corresponding to the closed region, of which an outline of the portion is the outer annular line, has a different level on a surface thereof from a surface of the wall part, and wherein portions of the displaying part adjacent to each other, out of portions of the displaying part corresponding to a plurality of closed regions, has respectively different levels on a surface of the portion of the displaying part with each other.

9. An electronic apparatus comprising: a casing; and a mark displaying structure on a surface of the casing comprising: a mark comprising an annularly closed outline; a wall part at least partly configuring the casing, the wall part exposed outside the casing and provided with an displaying hole defined by an outer circumferential edge corresponding to the annularly closed outline of the mark; and
a mark displaying member comprising; a displaying part received in the displaying hole; and an engaging part engaged with the wall part.

10. An electronic apparatus according to claim 9, wherein, in case where the mark comprises; at least one closed region defined between an outer annular line and an inner annular line which are positioned relatively outside and inside, and annularly closed; and another closed region defined by being enclosed by the inner annular line, a portion of the displaying part is respectively corresponding to each closed region.

11. An electronic apparatus according to claim 10, wherein the portion of the displaying part corresponding to each closed region is integrally formed.

12. An electronic apparatus according to claim 10, wherein the portion of the displaying part adjacent to each other, other than the portion of the displaying part corresponding to the closed region, is independently formed.

13. An electronic apparatus according to claim 12, wherein, in case where a plurality of closed regions at least defined by the inner annular line is included in a predetermined closed region out of a plurality of closed regions, a portion defined by the plurality of closed regions is integrally formed.

14. An electronic apparatus according to claim 12, wherein, in case where a plurality of the marks are displayed, the closed region of each of the plurality of marks having the same number in order in an inward direction from the outline is integrally formed.

15. An electronic apparatus according to claim 9, wherein a light source is provided, and wherein the mark displaying part is formed of a transparent material.

16. An electronic apparatus according to claim 10, wherein portion of the displaying part corresponding to the closed region, of which an outline of the portion is the outer annular line, has a different level on a surface thereof from a surface of the wall part, and wherein portions of the displaying part adjacent to each other, out of portions of the displaying part corresponding to a plurality of closed regions, has respectively different levels on a surface of the portion of the displaying part.
